(19) United States
(12) Patent Application Publication
(10) Pub. No.: US 2005/0240834 A1
(43) Pub. Date: Oct. 27, 2005

(54) Systems and methods for controlling extended functions

(75) Inventors: Stacey R. Rowlan, Phoenix, AZ (US); Desmond Duran Stelling, Glendale, AZ (US); Kenneth A. Varga, Glendale, AZ (US)

Correspondence Address: Squire, Sanders & Dempsey L.L.P.;Two Renaissance Square, Suite 2700, 40 North Central Avenue, Phoenix, AZ, 85004-4498, US

(73) Assignee: Aviation Communication & Surveillance Systems LLC

(21) Appl. No.: 10/815,114

(22) Filed: Mar. 30, 2004

(51) Int. Cl. G06F 11/00

(52) U.S. Cl. 714/47

(57) ABSTRACT

A system includes a first processor that performs a first self test process in response to a first actuation of a provided test control by a user of the system and a second processor that performs the second self test process in response to a second actuation of the test control prior to lapse of a first predefined period of time and terminates the second self test process in response to a third actuation of the test control by the user of the system, wherein the third actuation is maintained for more than a second predetermined period of time. In effect, a single test control formerly dedicated to a legacy processor is actuated to activate and control self testing of an additional processor.

### FIELD OF THE INVENTION

Embodiments of the present invention relate to systems that have been expanded to include new functions having new information to display without interfering with the methods for controlling legacy functions and providing legacy displays.

### BACKGROUND OF THE INVENTION

In a conventional cockpit, numerous line replaceable units (LRUs) cooperate to perform test functions and operational functions. Test functions include system tests, self tests, system configuration, and LRU configuration. As conventional systems are considered for functional expansion, frequently additional functions are desired, however, front panel space for controls and displays is limited and generally dedicated to the existing functions. A method is needed to provide cooperation among the legacy functions and the new functions without interfering with methods for controlling legacy functions or displaying information from legacy functions. By avoiding such interference, the legacy LRUs need not be redesigned. The redesign of existing functions may decrease reliability by inadvertently including or unavoidably including failure modes. Generally, redesign of an LRU is costly due to the cost of qualification testing as may be required by a regulatory agency such as the Federal Aviation Administration to assure high reliability and proper handling of failure modes.

Without systems and methods according to various aspects of the present invention, systems for virtually any purpose cannot be expanded without incurring costs and delays that may be economically adverse to the goals these systems would otherwise achieve including, for example, safety of personnel and protection of property.

### SUMMARY OF THE INVENTION

A method according to various aspects of the present invention controls the performance of self testing and extended self testing. The method is performed by a system that includes a first self test process and a second self test process. The method performed by the system, includes in any order: (a) performing the first self test process in response to a first actuation of a test control by a user of the system; (b) performing the second self test process in response to a second actuation of the test control prior to lapse of a first predefined period of time; and (c) terminating the second self test process in response to a third actuation of the test control by the user of the system, wherein the third actuation is maintained for more than a second predetermined period of time.

A system according to various aspects of the present invention includes a first processor and a second processor. The first processor performs a first self test process in response to a first actuation of a provided test control by a user of the system. The second processor that performs the second self test process in response to a second actuation of the test control prior to lapse of a first predefined period of time and terminates the second self test process in response to a third actuation of the test control by the user of the system. The third actuation is maintained for more than a second predetermined period of time.

### BRIEF DESCRIPTION OF THE DRAWING

Embodiments of the present invention will now be further described with reference to the drawing, wherein like designations denote like elements, and:

FIG. 1 is a functional block diagram of an expanded system having legacy functions and new functions;

FIG. 2 is a state change diagram of processes performed by the legacy and new functions of the system of FIG. 1; and

FIG. 3 is a functional block diagram of a terrain and traffic collision avoidance system according to various aspects of the present invention.

### DETAILED DESCRIPTION OF THE PREFERRED EMBODIMENTS

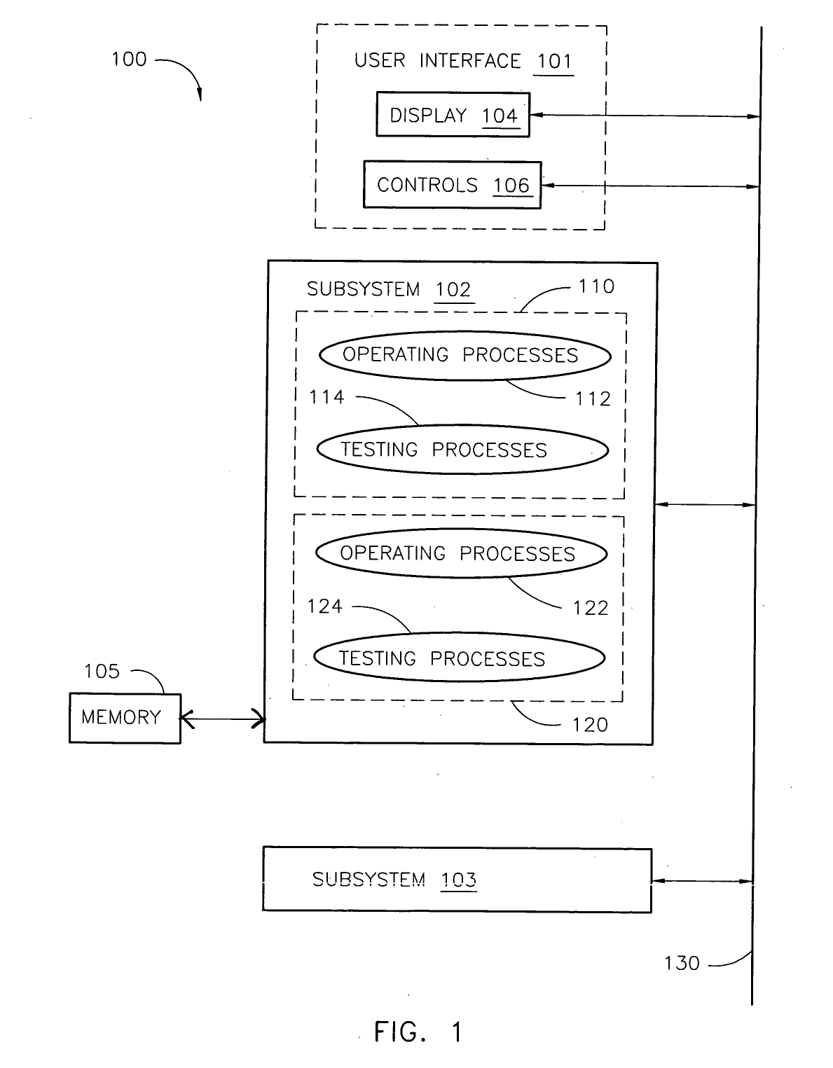

When developing a new product design to include functions of a prior product design and new functions, it may be impractical to add new user interface controls for the new functions. In addition, it may be desirable to rely to a comparatively great extent on results of testing the prior product to reduce the cost of testing the new product design and/or individual new products. These objectives are met in systems according to the present invention. For example, system 100 of FIG. 1 includes user interface 101, subsystem 102, subsystem 103 all coupled to interconnections 130. User interface 101 includes display 104 and controls 106. Subsystem 102 is coupled to memory 105 for receiving programs and data from memory 105 (e.g., initialization, updates, or mission configuration); and, for writing data to memory (e.g., recording operation, faults, measurements, or results of analysis). System 100 may perform any machine control or data control function, preferably where system 100 is desired to perform with comparatively high reliability. In one implementation, system 100 is part of a host aircraft and notifies a pilot of the host aircraft for aircraft collision avoidance. In other implementations system 100 controls a host vehicle for safe operation. In still other implementations, system 100 provides secure access to information for the protection of personnel, property, and/or data. In yet other implementations, system 100 provides accurate measurement, control, and/or analysis of physical, chemical, and biological processes.

System 100 may be packaged in any number of line replaceable units (LRUs), for example, for economical maintenance and configuration control. For example, user interface 101, subsystem 102, and subsystem 103 may constitute three LRUs. Interconnections between these functions may be implemented in any conventional manner (e.g., discrete signals, buses, conductors, fiber optics, wireless links, or networks).

Subsystem 102 represents a new product design that includes functions 110 of a prior product design and new functions 120. The prior design has been tested (e.g. certified to comply with quality and performance standards) and the implementation of new functions is desired to have a minimal impact on the need for repeating such testing. Functions 110 and 120 may be implemented in any mix of circuitry (e.g., analog circuits, logic, memory, and processors) and software (e.g., built in, obtained from memory 105, or obtained via interconnections 130). Functions 110 (120) include operating processes 112 (122) and testing processes 114 (124). An operating process includes any process that facilitates accomplishing a performance goal of system 100. A testing process includes any process that establishes configuration, initialization, self tests, calibration, interface tests, or system tests for confidence, maintenance, or repair. In one implementation, prior functions 110 and new functions 120 are hosted on independent processing platforms.

In the prior design, prior functions 110 received input from controls 106 and provided output to display 104. In subsystem 102, functions 110 continue to receive input from controls 106 and provide output to display 104. According to various aspects of the present invention, testing processes 124 receive input from controls 106 without interfering with prior functions 110. In other words, controls that were part of the legacy product design may he used according to various aspects of the present invention, in one or more new ways that are distinguished as applying to the new functions.

Controls 106 include one or more conventional user interface input devices. A control may include a physical switch having any number of positions (e.g., a momentary contact push button, an SPST toggle switch, or a portion of a compound rotary or slide switch), or a pointing device used with a presentation of a soft switch on a display (e.g., a GUI dialog box button, a menu item, or an icon). Various ways of effecting user input using such a control are collectively referred to herein as actuating the control. The control may be idle (no actuation in progress) or held (maintains actuation). The transitions between idle and held states are referred to herein as set (begins actuation) and release (ends actuation). Actuating and or monitoring (124) of actuating provides one or more signals to convey any one or more of the following: the current position of the control for a multiple position control (e.g., on, off, test, normal), the current state of the control for a multiple state control (e.g., a value in memory that tracks a soft control), a time when a change of position or state occurred, a duration between immediately preceding changes of position or state.

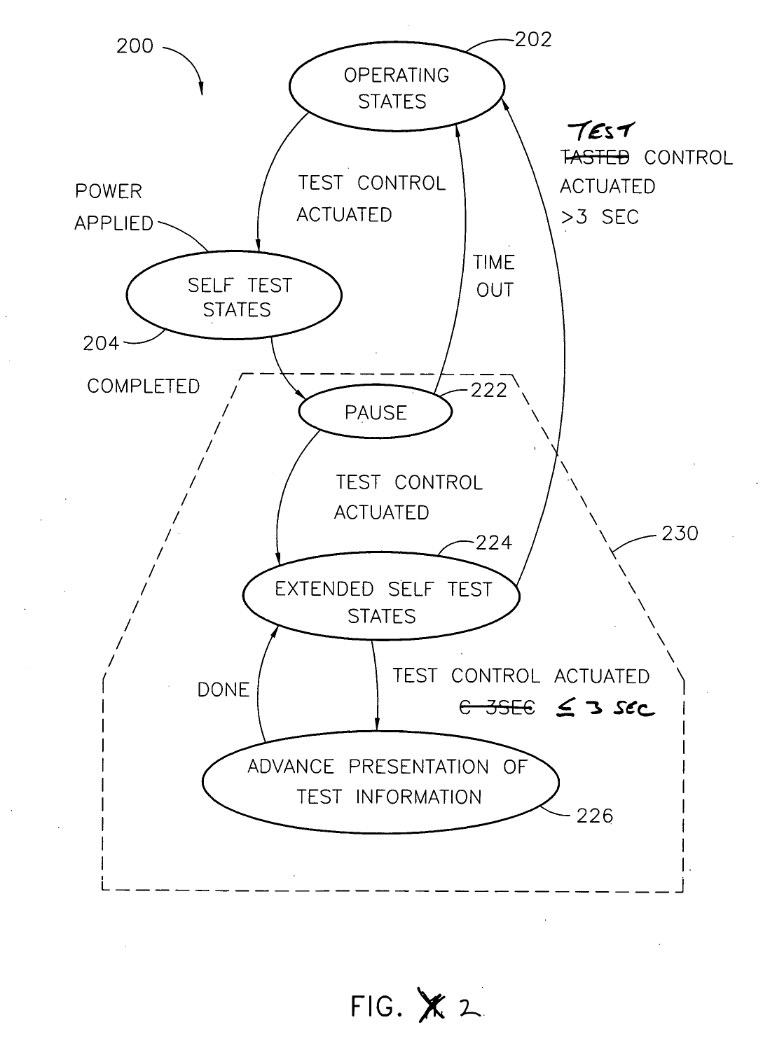

In a preferred implementation, controls 106 includes a mechanical momentary contact SPST switch suitably debounced to provide a binary signal that is asserted when set or held (either positive or negative logic) and not asserted when released or idle. Operation of the control is discussed with reference to test processes 114 and test processes 124. Consequently, this control is hereinafter called the test control. Changes of state associated with the test control are discussed with reference to FIG. 2 below. Nevertheless, other implementations may use other conventional controls and techniques (e.g., a first icon or menu item clicked for set and a second icon or menu item clicked for release). Further, the shared control may be shared between any of process of prior functions 110 and any process of new functions 120 without departing from the scope of this invention.

In operation, processes of subsystem 102 (performed by any number of processors) have states 200 of FIG. 2 and transitions between states. The state of a process is generally observed at any particular point in time as the values of all variables (e.g., registers and memory locations) used by the process including the program counter governing instruction execution. Although each process may have its own state, subsystem 102 is considered to be in only one of the states 202-226 at any time. In an exemplary implementation, testing processes 114 and testing processes 124 each monitor the state of the test control 106. Generally, a change of state of the test control causes a change of state of a process of subsystem 102 as indicated in FIG. 2.

In response to application of primary power, testing processes 114 is activated to govern self testing according to any number of self test states 204. When self testing is completed, transition is made to pause state 222.

Pause state 222 is exited on the soonest to occur of two events. First, a transition to operating states 202 occurs in response to lapse of a first predetermined time measured during the pause state (e.g., about 3 seconds). The first predetermined time may be effected by initialization (114 or 204), configuration (e.g., per software read from memory 105), or prior action via user interface 101. A time in the range from about 2 seconds to about 10 seconds provides adequate opportunity for a trained user to recognize that self tests are completed and extended self tests are available to be executed as desired. Second, pause state 222 is exited in response to the test control being actuated (e.g., idle, then set, then released; or idle, then set and held). Accordingly, transition is made to extended self test states 224 where testing processes 124 govern extended self testing according to any number of extended self test states.

Any of extended self test states 224 are exited on the soonest to occur of two events. First, in response to the test control being actuated (e.g., held; or set and held) for more than a second predetermined time (e.g., about 3 seconds) a transition is made to operating states 202 governed by operating processes 112 and 122. The second predetermined time may be effected by initialization (114 or 204), configuration (e.g., per software read from memory 105), or prior action via user interface 101. A time in the range from about 1 second to about 10 seconds provides a suitable indication that the user intends to exit the extended self test states 224. Second, in response to the test control being actuated (e.g., held; or set and held), transition is made to state 226 where an advance is made in displaying a presentation of test information.

An advance includes any change in presentation that permits viewing of additional detail or information. For example, an advance may be a next page of test information in a series of pages of test information. An advance may be a zoom in or out in a graphic presentation to reveal more detail or more surround. An advance may be a repositioning of a locus of the presentation, such as a smooth scroll forward or backward by an incremental amount that is less than a full page of test information. After completion of an advance (or no further advance is practical), transition is made back to extended self test states 224.

In an alternate implementation, while the test control is held, advancing is repeated with a suitable delay between repetitions. Advance presentation state 226 exits on the soonest to occur of two events. First, in response to there being no practical further advancement transition is made back to a suitable state of extended self test states 224. Second, in response to release of the test control, transition is made back to a suitable state of extended self test states 224.

According to various aspects of the present invention, testing of the design of subsystem 102 may be simplified by reducing or omitting testing related to functions not affected by the addition of new functions 120. As to the implementation of states 200, testing of state logic for states outside perimeter 230 may be reduced or omitted because the change in state logic is predominantly within boundary 230. Operating states 202 and self test states 204 may be implemented by prior functions 110 and states 222 through 226 may be implemented by new functions 120.

The following method and portions of it may be implemented for performance by a system analogous to system 100 in accordance with states analogous to states 200. A method according to various aspects of the present invention controls the performance of a legacy function and a new function. The method is performed by a system that includes a legacy process that performs the legacy function and a new process that performs the new function. The method performed by the system, includes in any order: (a) performing the legacy process in response to a first actuation of a control by a user of the system; (b) performing the new process in response to a second actuation of the control prior to lapse of a first predefined period of time; (c) controlling the new function in accordance with one or more third actuations of the control by the user of the system, each such third actuation being held for less than a second predetermined period of time; and (d) terminating performance of the new process in response to a fourth actuation of the control by the user of the system, wherein the fourth actuation is held for more than a second predetermined period of time. An actuation of the control includes any transition between states of the control (e.g., idle and held for a binary control). In a system that performs methods as discussed above, a signal from the control (e.g., set and release for a binary control) may indicate a state transition and the method may include receiving and acting in accordance with such a state transition signal.

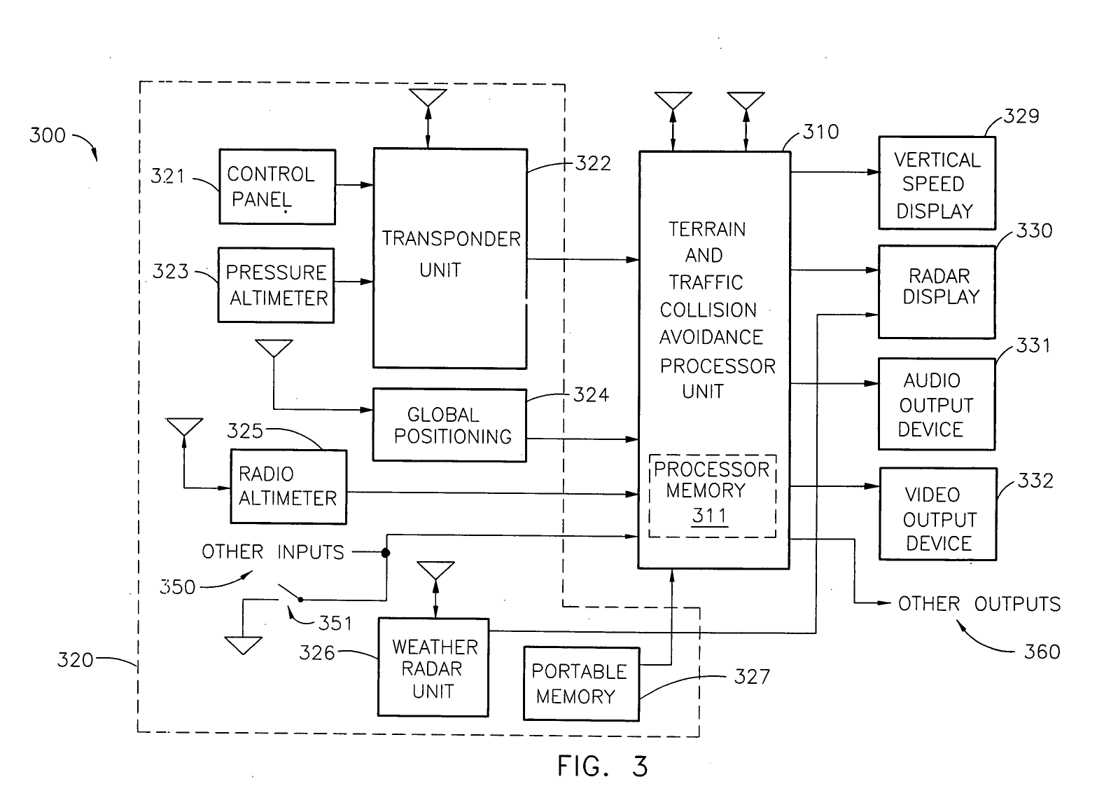

An implementation of system 100 for air traffic and terrain collision avoidance comprises line replaceable units and may include the line replaceable units of FIG. 3. System 300 includes a conventional transponder 322 cooperating with a transponder control panel 321 and a pressure altimeter 323; a Global Positioning System (GPS) receiver 324; a radio altimeter 325; and a weather radar unit (WXR) 326. These LRUs comprise data acquisition subsystems for cooperation with a terrain and traffic collision avoidance processor unit 310. A portable memory 327 may provide conventional configuration information to unit 310. Unit 310 provides information for vertical speed display 329, radar display 330 (also cooperating with weather radar unit 326), audio output device 331, and video output device 332. Unit 310 may be a conventional T²CAS as marketed by Aviation Communication and Surveillance Systems as modified to perform methods discussed above. Functions performed by system 100 as discussed above may be performed by portions of system 600 as follows: display 104 corresponds to radar display 330. Subsystem 102 with prior functions 110 and new functions 120 correspond to processor 310 with traffic data acquisition unit 311, and terrain data acquisition unit 312. More particularly, self tests of unit 311 correspond to testing processes 114 and self tests of unit 312 correspond to testing processes 124. The test control (part of 106) corresponds to test switch 351 that provides a discrete input (part of “other inputs” 350). Interconnections 130 are implemented according to conventional avionics signaling standards (e.g., ARINC 453 and 708).

A presentation of test information for system 300 may include a description of the configuration of system 300 (e.g., part numbers of unit 310, its components (hardware and software), and cooperating LRUs), settings (e.g., constants and initial values for parameters and variables for unit 310, its components (hardware and software), and cooperating LRUs (e.g., settings for ARINC interfaces)), results of tests (e.g., pass/fail) of any portion of system 300, guidance for maintenance including adjustments for calibration), and logs of events that occurred during operation of system 300 prior to formation of the presentation. Such a presentation may be divided into pages of related information. Advancing through the presentation one page at a time may be accomplished by actuating the test switch.

Systems according to the present invention may be used in any vehicular or supervisory application (e.g., automobile displays, watercraft radar displays, or systems for monitoring or controlling vehicular traffic such as stationary air traffic control systems).

Unless contrary to physical possibility, the methods and systems described herein may be performed in any sequence and/or combination; and, the components of respective embodiments may be combined in any manner.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

1. A method for controlling the performance of self testing and extended self testing, the method performed by a system that includes a first self test process and a second self test process, the method performed by the system, the method comprising:
performing the first self test process in response to a first actuation of a test control by a user of the system;
performing the second self test process in response to a second actuation of the test control prior to lapse of a first predefined period of time; and
terminating the second self test process in response to a third actuation of the test control by the user of the system, wherein the third actuation is maintained for more than a second predetermined period of time.

2. The method of claim 1 wherein the test control provides a one-bit binary signal having an actuated state and a non-actuated state.

3. The method of claim 1 further comprising advancing a presentation of test information in response to a fourth actuation of the test control by the user of the system during performance of the second self test process, wherein the fourth actuation is maintained for less than the second predefined period of time.

4. The method of claim 1 wherein the first self test process performs legacy functions of the system and the second self test process performs extended functions of the system.

5. A memory comprising indicia of instructions for performing the method of claim 1.

6. A system that performs self testing and extended self testing, the system comprising:
means for performing the first self test process in response to a first actuation of a provided test control by a user of the system;
means for performing the second self test process in response to a second actuation of the test control prior to lapse of a first predefined period of time; and
means for terminating the second self test process in response to a third actuation of the test control by the user of the system, wherein the third actuation is maintained for more than a second predetermined period of time.

7. The system of claim 6 wherein the test control provides a one-bit binary signal having an actuated state and a non-actuated state.

8. The system of claim 6 further comprising means for advancing a presentation of test information in response to a fourth actuation of the test control by the user of the system during performance of the second self test process, wherein the fourth actuation is maintained for less than the second predefined period of time.

9. The system of claim 6 wherein the first self test process performs legacy functions of the system and the second self test process performs extended functions of the system.

10. A system comprising:
a first processor that performs a first self test process in response to a first actuation of a provided test control by a user of the system; and
a second processor that performs the second self test process in response to a second actuation of the test control prior to lapse of a first predefined period of time and terminates the second self test process in response to a third actuation of the test control by the user of the system, wherein the third actuation is maintained for more than a second predetermined period of time.

11. The system of claim 10 wherein the test control provides a one-bit binary signal having an actuated state and a non-actuated state.

12. The system of claim 10 further comprising means for advancing a presentation of test information in response to a fourth actuation of the test control by the user of the system during performance of the second self test process, wherein the fourth actuation is maintained for less than the second predefined period of time.

13. The system of claim 10 wherein the first processor further performs legacy functions of the system.

14. The system of claim 10 wherein the first processor performs a traffic collision avoidance function and the second processor performs a terrain collision avoidance function.
